(19) United States
(12) Patent Application Publication
(10) Pub. No.: US 2006/0045652 A1
(43) Pub. Date: Mar. 2, 2006

(54) Substrate processing apparatus and method

(75) Inventor: Katsuhiko Miya, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/132,564

(22) Filed: May 19, 2005

(30) Foreign Application Priority Data
Jul. 2, 2004 (JP) 2004-196333

(51) Int. Cl. B25J 3/00

(52) U.S. Cl. 414/1

(57) ABSTRACT

As inert gas is ejected toward the rim of the other major surface W2 of the substrate W from a front portion of a substrate supporting head 71 which is opposed against an approximately central portion of the other major surface W2 of the substrate W, the substrate W is sucked owing to the Bernoulli effect and supported approximately horizontally by the substrate supporting head 71 without contacting anywhere. When a control unit 80 drives an actuator 74, the substrate supporting head 71 and a head supporting arm 72 ascend and descend as one integrated unit, and the substrate W which is sucked and supported approximately horizontally by the substrate supporting head 71 moves upward and downward. Thus, as the substrate supporting head 71 ascends and descends, the gap between an opposing surface 5b of a spin base 5 and a rim portion of the other major surface W2 of the substrate W is adjusted to any desired value and uniformly all around the circumference of the substrate W.

### CROSS REFERENCE TO RELATED APPLICATION

The disclosure of Japanese Patent Application No. 2004-196333 filed Jul. 2, 2004 including specification, drawings and claims is incorporated herein by reference in its entirety.

### BACKGROUND OF THE INVENTION

1. Field of the Invention

The present invention relates to a substrate processing apparatus and method which performs processing such as cleaning on various types of substrates such as semiconductor wafers, glass substrates for photomask, glass substrates for liquid crystal display, glass substrates for plasma display and optical disk substrates.

2. Description of the Related Art

Known as a substrate processing apparatus of this type is a substrate processing apparatus in which a substrate is held horizontally as it is slightly floated from a surface of a rotary base (base member) which is to seat substrates, a processing liquid such as a photo-resist liquid, a cleaning liquid, a rinsing liquid, an etching liquid, and the like is supplied to one major surface (top surface) which is one of the two major surfaces of the substrate facing above, thereby processing predetermined substrate processing to the top surface. In this substrate processing apparatus, plural substrate support pins are disposed upright on the rotary base which is to seat substrates, and the substrate support pins position and hold a rim of the substrate. As the substrate rotates while supplying the processing liquid, the processing liquid spreads all over the top surface and uniform surface processing is performed.

In the conventional apparatus, since the substrate is held as it is slightly floated from the surface of the rotary base as described above, it is possible to avoid damaging of the other major surface (bottom surface) of the substrate which will otherwise occur if the substrate is mounted abutting on the rotary base. However, a different problem arises that misty processing liquid splashed during the substrate processing circles down and adheres to the bottom surface of the substrate and contaminates the bottom surface of the substrate. A technique to solve this problem noting this proposes disposing an up-down member between the substrate and the rotary base (See Japanese Patent No. 2845738, for instance.).

In the substrate processing apparatus described in the Japanese Patent No. 2845738, during the substrate processing which creates the mist (misty processing liquid), the up-down member disposed between the substrate and the rotary base is driven toward above (upward position) by a driver. This reduces the gap between the bottom surface of the substrate and the top surface of the up-down member, preventing the created mist from circling down over to the bottom surface of the substrate. Meanwhile, when there is no mist, that is, when the rotary base is in a halt for the purpose of loading/unloading of the substrate, the up-down member is driven toward below (downward position) and the gap between the bottom surface of the substrate and the rotary base expands. As a result, the substrate is transported easily by means of a transportation arm or the like.

### SUMMARY OF THE INVENTION

However, since only the proximity of the up-down member to the bottom surface of the substrate prevents circling down of the mist in the apparatus described in Japanese Patent No. 2845738, the preventive effect is not necessarily sufficient. For instance, while it is desirable that the up-down member comes as close as possible to the bottom surface of the substrate for enhancement of the effect of preventing circling down of the mist, bending of the substrate, the metrication error of the up-down member, the assembly accuracy of the apparatus, or other factor may impose a limitation against the up-down member whose size is about the same as that of the substrate to position closely to the bottom surface of the substrate. Hence, in a structure where the up-down member to move closer to the bottom surface of the substrate, it is not possible to sufficiently prevent the contamination of the bottom surface of the substrate by the processing liquid which jumps over toward or circles down to the bottom surface of the substrate.

The countermeasures may be to dispose substrate support pins such as chuck pins which abut on the rim of the substrate and hold the substrate closer to the rotary base, to thereby position the substrate close to the rotary base. However, the attempt to position the substrate closer to the rotary base using the substrate support pins merely results in the proximity of substrate supporting sections alone to the rotary base, and it is still difficult to achieve uniform proximity to the rotary base all around the circumference of the substrate. Particularly in the case that purging is carried out by introducing inert gas into the space between the bottom surface of the substrate and the rotary base, since the inert gas introduced between the bottom surface of the substrate and the rotary base gushes out from the rim of the substrate outward along the diameter direction of the substrate, force away from the rotary base acts upon the substrate due to the pressure of gas flows. It is therefore even more difficult to position the substrate uniformly close to the rotary base all around the circumference of the substrate.

The present invention has been made in light of the problems above. Accordingly, the object of the present invention is to provide a substrate processing apparatus and method which effectively prevents contamination of the other major surface of a substrate with a processing liquid while avoiding damaging of the other major surface of the substrate and favorably performs substrate processing.

According to a first aspect of the present invention, there is provided a substrate processing apparatus which performs predetermined processing by supplying a processing liquid to one major surface of a substrate, comprising: a substrate supporting device which includes a substrate supporting head and which ejects gas from a front portion of said substrate supporting head toward a rim of the other major surface of said substrate while the front portion of said substrate supporting head is opposed against an approximately central portion of the other major surface of said substrate, whereby said substrate supporting head sucks said substrate by the Bernoulli effect and supports said substrate approximately horizontally without contacting said substrate; a base member which has an opposing surface opposed against the other major surface of said substrate and which is provided with a dent which is formed approximately at a central portion of the opposing surface, and a plane size of which is larger than a plane size of said substrate supporting head, whereby at least a rear portion of said substrate supporting head can be positioned inside the dent below a plane of the opposing surface; and an adjuster which moves said substrate sucked and supported by said substrate supporting head upward and downward relative to said base member, whereby a gap between the opposing surface of said base member and a rim portion of the other major surface of said substrate is adjusted.

According to a second aspect of the present invention, there is provided a substrate processing method in which predetermined processing is performed by supplying a processing liquid to one major surface of a substrate, comprising steps of: ejecting gas from a front portion of a substrate supporting head toward a rim of the other major surface of said substrate while the front portion of said substrate supporting head is opposed against an approximately central portion of the other major surface of said substrate, for said substrate supporting head to suck said substrate by the Bernoulli effect and to support said substrate approximately horizontally without contacting said substrate; and adjusting a gap between a rim portion of the other major surface of said substrate and an opposing surface of a base member, the opposing surface being opposed against the other major surface of said substrate, said base member being provided with a dent which is formed approximately at a central portion of the opposing surface, and a plane size of which is larger than a plane size of said substrate supporting head, wherein in adjusting the gap, at least a rear portion of said substrate supporting head can be positioned inside the dent below a plane of the opposing surface.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a drawing which shows a preferred embodiment of a substrate processing apparatus according to the present invention.

FIG. 2 is a plan view of the substrate processing apparatus of FIG. 1 as it is viewed from above.

FIG. 3 is a drawing describing the relationship between the position of the spin base and the position of the substrate.

FIG. 4 is a flow chart of the operation of the substrate processing apparatus which is shown in FIG. 1.

FIGS. 5A and 5B are drawings which schematically show the operation of the substrate processing apparatus which is shown in FIG. 1.

### DETAILED DESCRIPTION OF THE PREFERRED EMBODIMENTS

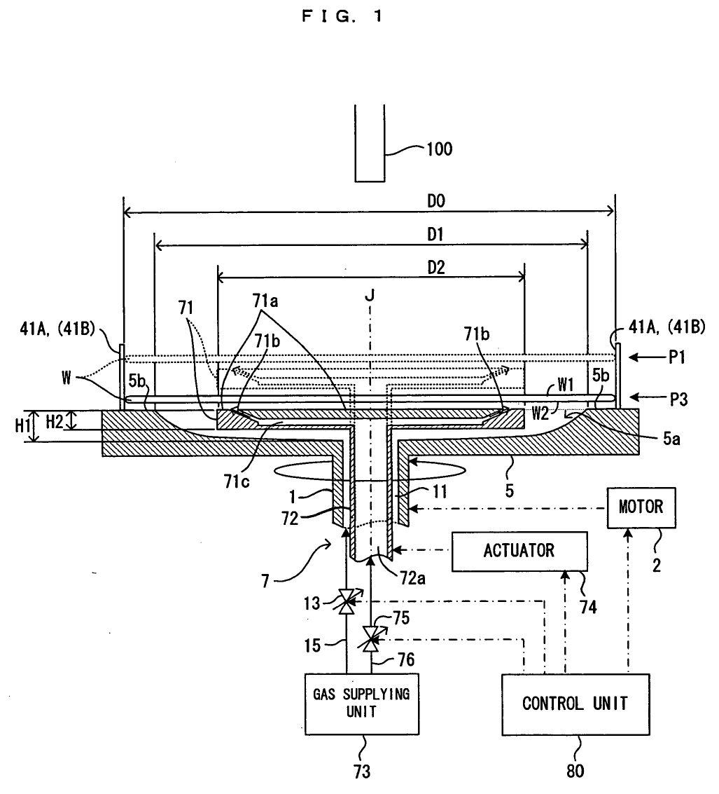

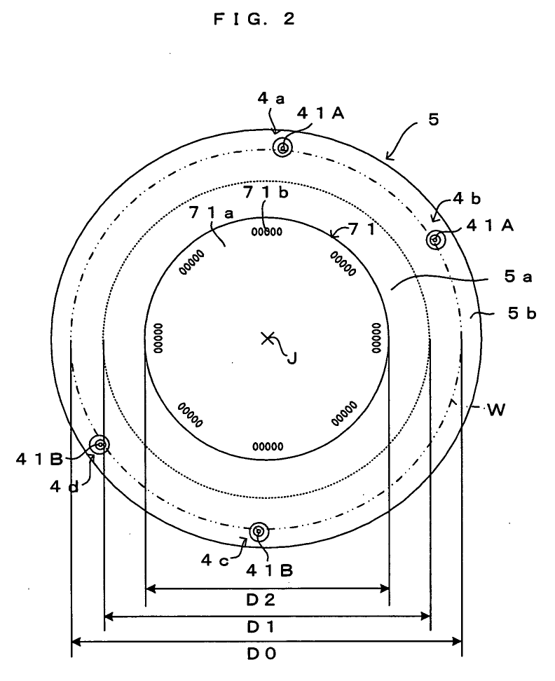

FIG. 1 is a drawing which shows a preferred embodiment of a substrate processing apparatus according to the present invention. FIG. 2 is a plan view of the substrate processing apparatus of FIG. 1 as it is viewed from above. This substrate processing apparatus is an apparatus in which a chemical solution such as a chemical drug, an organic solvent or the like and a rinsing liquid such as pure water, DIW, or the like are supplied as the “processing liquid” of the present invention to one major surface W1, which is one of the both major surfaces, of a substrate W such as a semiconductor wafer, thereby processing one major surface W1 of the substrate W and a rim portion of the other major surface W2 of the substrate W. To be more specific, this substrate processing apparatus is capable of supplying the processing liquid to one major surface W1 of the substrate W and processing the one major surface W1. In addition, by supplying the processing liquid to one major surface W1 of the substrate W from a nozzle 100, the substrate processing apparatus is capable of processing (bevel processing) the rim portion of the other major surface W2 of the substrate W with the processing liquid which circles down over to the other major surface W2 of the substrate W from one major surface W1 of the substrate W via a circumferential edge surface of the substrate W. Further, contamination of a non-processing area (device-forming area) other than the rim portion in the other major surface W2, which is caused as the processing liquid jumps back to the other major surface W2 of the substrate W or the misty processing liquid circles down to the other major surface W2, is prevented in the following manner.

In this substrate processing apparatus, a hollow rotation shaft 1 is linked to a rotation shaft of a motor 2, and when the motor 2 is driven, the rotation shaft 1 rotates about a vertical axis J. A spin base 5, whose plane size is slightly larger than that of the substrate W and which corresponds to the “base member” of the present invention, is fixed to and integrated with the top end of the rotation shaft 1 by a fastening device such as a screw. Hence, when driven by the motor 2, the spin base 5 rotates about the vertical axis J. In this embodiment, the motor 2 thus corresponds to the “rotating device” of the present invention. The structure and an characteristic of the spin base 5 will be described in detail later.

This substrate processing apparatus is further equipped with a substrate elevating mechanism 7 which moves the substrate W upward and downward while supporting the substrate W approximately horizontally without contacting anywhere. The substrate elevating mechanism 7 makes it possible that the substrate W and the spin base 5 are positioned close to each other, while permitting loading/unloading of the substrate W by a substrate transportation robot or the like. In other words, when the substrate W and the spin base 5 are positioned close to each other, a transportation arm of a substrate transportation robot or the like can not be inserted into the gap between the two. Noting this, the substrate elevating mechanism 7 performs delivery and receipt of the substrate W with the substrate transportation robot at a substrate transfer position P1 which is a position sufficiently spaced upward from the spin base 5, and also transports the substrate W to a substrate processing position P3 at which the substrate W and the spin base 5 are positioned close to each other. To be more specific, the substrate elevating mechanism 7:
receives an unprocessed substrate W from the substrate transportation robot at the substrate transfer position P1;
positions thus received unprocessed substrate W to the substrate processing position P3;
positions a processed substrate W which is performed predetermined substrate processing to the substrate transfer position P1; and
hands the processed substrate W over to the substrate transportation robot.

The substrate elevating mechanism 7 comprises a substrate supporting head 71, a head supporting arm 72, a gas supplying unit 73, and an actuator 74. Inert gas such as nitrogen gas is ejected from a front portion of the substrate supporting head 71 toward the other major surface W2 of the substrate W, whereby the substrate W is supported by the substrate supporting head 71 approximately horizontally without contacting anywhere. The head supporting arm 72 is hollow and cylindrical and is attached to a rear portion of the substrate supporting head 71 and supports the head. The gas supplying unit 73 is communicated with the hollow section of the head supporting arm 72 and is capable of supplying the inert gas to the substrate supporting head 71 via the head supporting arm 72. The actuator 74, such as a pneumatic cylinder and the like, moves the substrate supporting head 71 and the head supporting arm 72 along the up and down direction as one integrated unit.

The substrate supporting head 71 is at its central portion of the rear portion (bottom portion) fixed to a top end of the head supporting arm 72 as one integrated unit and is supported horizontally by the head supporting arm 72. The head supporting arm 72 is disposed penetrating the hollow section of the rotation shaft 1 coaxially with the vertical axis J and is structured to ascend and descend freely. The head supporting arm 72 is linked with the actuator 74, and therefore, when a control unit 80 which controls the whole of the apparatus drives the actuator 74, the substrate supporting head 71 and the head supporting arm 72 ascend and descend as one integrated unit. In this embodiment, the actuator 74 thus corresponds to the “up-and-down driver” of the present invention which moves the substrate supporting head 71 upward and downward.

A front portion (upper portion) of the substrate supporting head 71 is opposed against an approximately central portion of the other major surface W2 of the substrate W, and therefore, as the inert gas which is ejected from the front portion of the substrate supporting head 71 floats up the substrate W, the substrate W is supported, with its one major surface W1 faced up, by the substrate supporting head 71 without contacting the substrate supporting head 71. The substrate supporting head 71 has a circular plate shape whose plane size D2 is smaller than a plane size D0 of the substrate W. A top surface 71a of the front portion of the substrate supporting head 71 is, as a supporting surface, opposed against and parallel to (i.e., horizontally) the other major surface W2 of the substrate W. Plural gas ejection outlets 71b open in a rim portion on the top surface 71a of the substrate supporting head 71, and it is possible to eject the inert gas from each gas ejection outlet 71b toward the other major surface W2 of the substrate W, upward and toward the rim of the substrate W.

As shown in FIG. 2, the plural gas ejection outlets 71b are arranged in the rim portion on the top surface 71a of the substrate supporting head 71. To be more specific, plural gas ejection outlets 71b (five gas ejection outlets 71b in this embodiment) are arranged linearly by small intervals to form a group of the gas ejection outlets 71b. And plural groups of the gas ejection outlets 71b (eight groups in this embodiment) are arranged equidistant from each other by predetermined intervals along the circumference. Each gas ejection outlet 71b has an oval shape which elongates outward along the diameter on the top surface 71a, and is formed inclined at a predetermined angle (which is preferably 20 through 40 degrees) with respect to the top surface 71a so that the inert gas is ejected toward the rim of the substrate W. This ensures that the inert gas is ejected from the gas ejection outlets 71b toward the rim of the other major surface W2 of the substrate W evenly along the circumferential direction about the vertical axis J. Since the inert gas is thus ejected from the respective gas ejection outlets 71b, the substrate W is sucked toward the top surface 71a by the Bernoulli effect and is floated up approximately horizontally.

The description is continued referring back to FIG. 1. The plural gas ejection outlets 71b formed on the top surface 71a of the substrate supporting head 71 are each communicated with a gas distributing space 71c which is created inside the substrate supporting head 71. The substrate supporting head 71 above, for example, may be structured with a receiver member which has a form of a dish and which is provided with a concave section inside, and a lid member which has a form of circular plate and whose top surface serves as the supporting surface 71a which is opposed against the bottom surface of the substrate W. As the lid member is fit into the receiver member, the substrate supporting head 71 which is provided with the gas distributing space 71c inside is structured. Further, inside of the hollow head supporting arm 72 functions as a gas supply path 72a which is along the vertical axis J. The top end of the gas supply path 72a is communicated with the gas distributing space 71c. And the bottom end of the gas supply path 72a is communicated with the gas supplying unit 73 via a pipe 76 in which a flow rate adjusting valve 75, which functions as both an on-off valve and a flow rate adjusting valve, is placed. Instead, an on-off valve and a flow rate adjusting valve may be placed in the pipe 76 independently of each other. In this embodiment, the substrate supporting head 71, the head supporting arm 72, and the gas supplying unit 73 thus functions as the “substrate supporting device” of the present invention.

The gap between the inner wall surface of the rotation shaft 1 and the outer wall surface of the head supporting arm 72 serves as a gas supply path 11. The gas supply path 11 is communicated with the gas supplying unit 73 via a pipe 15 in which a flow rate adjusting valve 13 is placed, and therefore, it is possible to supply the inert gas via the gas supply path 11 into the space which is created between the other major surface W2 of the substrate W and the top surface of the spin base 5 as the flow rate adjusting valve 13 opens and closes under control of the control unit 80.

To prevent the substrate W supported by the substrate supporting head 71 from moving in the horizontal direction, four holders 4a through 4d are disposed at the rim of the spin base 5 (FIG. 2). Of the four holders 4a through 4d, the holders 4a and 4b are fixed holders in which hold pins 41A abutting on and holding the substrate W are fixed, whereas the holders 4c and 4d are movable holders in which hold pins 41B abutting on and holding the substrate W are movable. The movable hold pins 41B are capable of moving away from and abutting on the edge surface of the substrate W in accordance with an operation signal from the control unit 80. The control unit 80 makes the movable hold pins 41B stay away from the edge surface of the substrate W and performs loading of the substrate W onto and unloading of the substrate W from the substrate supporting head 71. After the substrate W supported by the substrate supporting head 71 is positioned in an up-down direction to the substrate processing position P3, the movable hold pins 41B are positioned in horizontal direction to substrate holding positions which abut on the edge surface of the substrate W. In consequence, the movable hold pins 41B pinch the substrate W together with the fixed hold pins 41A and hold the substrate W horizontally. In this embodiment, the substrate supporting head 71 supports the substrate W approximately horizontally, and the four hold pins 41A, 41A, 41B, and 41B restrict the substrate W from moving in the horizontal direction. As such holders, the substrate holding mechanism disclosed in Japanese Patent Application Laid-Open Gazette No. 2004-146708 is used for example. The number and the arrangement of the holders may be determined freely. For instance, three holders may be prepared of which two may be fixed holders and the remaining one may be a movable holder. In this embodiment, the holders 4a through 4d thus correspond to the “holder” of the present invention which holds the substrate W.

The structure of the spin base 5 will now be described. The spin base 5 has a form of circular plate and is provided with a dent 5a in an approximately central portion of a top surface 5b which is opposed against the other major surface W2 of the substrate W. The dent 5a is concave upward and its plane form is circular. The dent 5a is formed such that its plane size D1 is larger than the plane size D2 of the substrate supporting head 71 and that its size of depth H1 is larger than the size of height H2 of the substrate supporting head 71 in the up-down direction. Hence, when the substrate supporting head 71 moves down, the substrate supporting head 71 can retract inside the dent 5a. That is, the top surface 71a of the substrate supporting head 71 is below the plane of the top surface 5b of the spin base 5. Further, the top surface 5b in a form of a ring surrounding the dent 5a serves as a substrate opposing surface 5b which is opposed against the other major surface W2 of the substrate W. This opposing surface 5b is horizontally (i.e., parallel to the top surface 71a of the substrate supporting head 71), and can be positioned parallel to and opposed against the rim portion of the other major surface W2 of the substrate W which is sucked and supported approximately horizontally by the substrate supporting head 71.

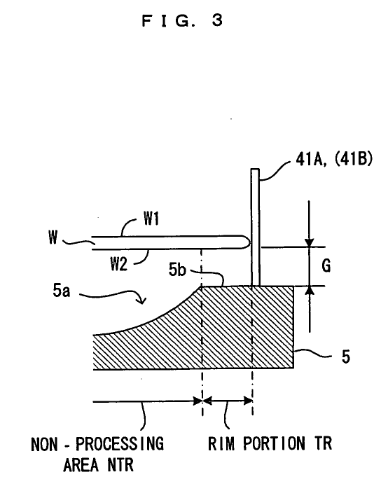

FIG. 3 is a drawing describing the relationship between the position of the spin base and the position of the substrate. More specifically, FIG. 3 shows the relationship between the position of the opposing surface 5b of the spin base 5 and that of a rim portion TR of the other major surface W2 of the substrate W. When the control unit 80 drives the actuator 74, the substrate supporting head 71 and the head supporting arm 72 ascend and descend as one integrated unit, and the substrate W which is sucked and supported approximately horizontally by the substrate supporting head 71 moves upward and downward while maintaining the parallel relationship between the position of the rim portion TR of the other major surface W2 and that of the opposing surface 5b of the spin base 5. Hence, as the substrate supporting head 71 ascends and descends, a gap G between the opposing surface 5b of the spin base 5 and the rim portion TR of the other major surface W2 of the substrate W is adjusted to any desired value and uniformly all around the circumference of the substrate W. Thus, in this embodiment, by moving the substrate supporting head 71 upward and downward, the gap G between the opposing surface 5b of the spin base 5 and the rim portion TR of the other major surface W2 of the substrate W is structured to be changeable.

Further, as shown in FIG. 1, the whole of the substrate supporting head 71 can be positioned inside the dent 5a of the spin base 5. That is, the top surface 71a of the substrate supporting head 71 is below the plane of the opposing surface 5b of the spin base 5. Therefore, in descending the substrate supporting head 71 for reduction of the gap G between the opposing surface 5b of the spin base 5 and the rim portion TR of the other major surface W2 of the substrate W, the substrate supporting head 71 will not be an obstacle. Hence, the opposing surface 5b of the spin base 5 and the rim portion TR of the other major surface W2 of the substrate W can be positioned sufficiently close to each other.

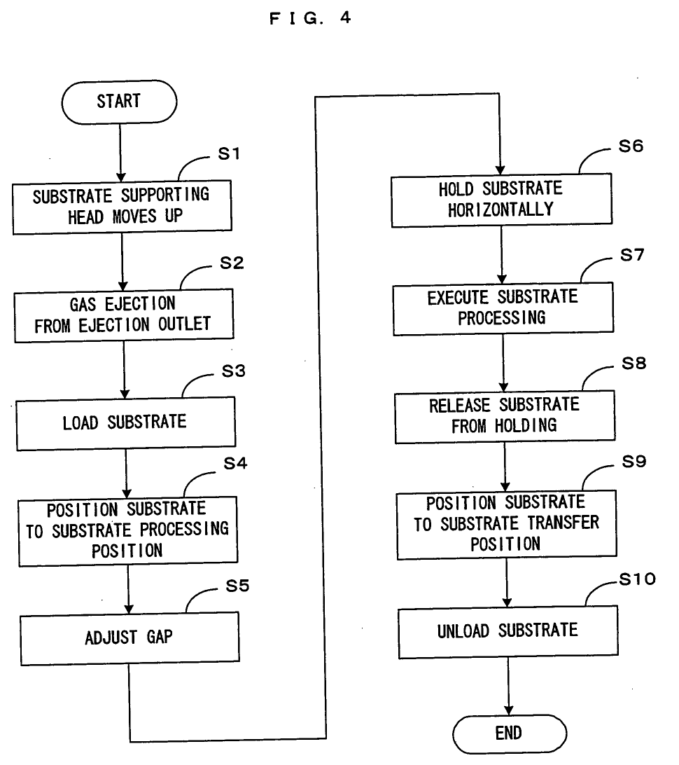

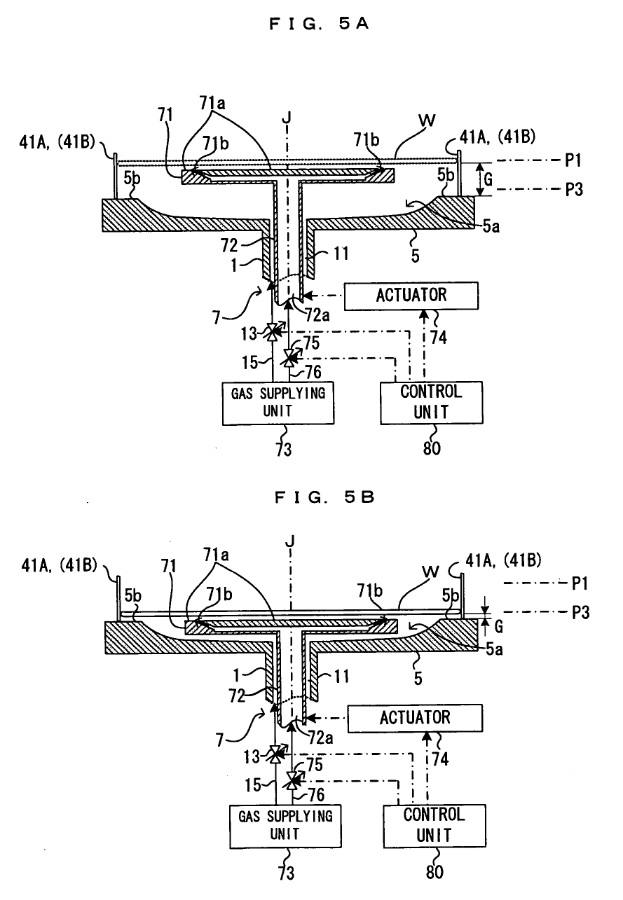

An operation of the substrate processing apparatus structured above will now be described with reference to FIGS. 4, 5A and 5B. FIG. 4 is a flow chart of the operation of the substrate processing apparatus which is shown in FIG. 1. FIGS. 5A and 5B are drawings which schematically show the operation of the substrate processing apparatus which is shown in FIG. 1. First, as shown in FIG. 5A, the control unit 80 drives the actuator 74 to ascend, thereby moving the substrate supporting head 71 and the head supporting arm 72 upward as one integrated unit (Step S1). This enlarges the gap G between the opposing surface 5b of the spin base 5 and the rim portion TR of the other major surface W2 of the substrate W. As the top surface 71a of the substrate supporting head 71 moves up to just below the substrate transfer position P1 which is sufficiently spaced upward from the spin base 5 and stops, the control unit 80 opens the flow rate adjusting valve 75, and the inert gas is ejected at a predetermined flow rate from the gas ejection outlets 71b of the substrate supporting head 71 (Step S2). As herein referred to, “sufficiently spaced” means a separation to an extent that the transportation arm of the substrate transportation robot or the like can be inserted between the substrate W and the spin base 5. This makes it possible for the substrate supporting head 71 to receive a substrate W when the substrate W is transported to the substrate transfer position P1. The control unit 80 may move up the substrate supporting head 71 during ejection of the inert gas after causing ejection of the inert gas from the gas ejection outlets 71b, or may move up the substrate supporting head 71 at the same time as ejection of the inert gas.

Following this, an unprocessed substrate W is loaded into the apparatus by the transportation arm of the substrate transportation robot or the like and transported to the substrate transfer position P1, the transportation arm of the substrate transportation robot then retracts away from the unprocessed substrate W, and the unprocessed substrate W is handed over to the substrate supporting head 71 (Step S3). Owing to the inert gas ejected toward the other major surface W2 of the substrate W, upward and toward the rim of the substrate W, the substrate W is sucked by the Bernoulli effect and supported by the substrate supporting head 71 without contacting the substrate supporting head 71. The hold pins 41A and 41B of the holders 4a through 4d disposed at the rim of the spin base 5 restrict the unprocessed substrate W from moving in the horizontal direction.

Next, the unprocessed substrate W, as it is sucked and supported approximately horizontally by the substrate supporting head 71, moves down when the control unit 80 drives the actuator 74 to descend. At this stage, since the unprocessed substrate W descends while restricted from moving in the horizontal direction by the hold pins 41A and 41B, the substrate W is guided smoothly toward the substrate processing position P3 without flying out sideways from the substrate supporting head 71. This reduces the gap G between the opposing surface 5b of the spin base 5 and the rim portion of the other major surface W2 of the substrate W. When the unprocessed substrate W arrives at the substrate processing position P3, the control unit 80 stops driving the actuator 74. In this manner, as shown in FIG. 5B, the substrate W is positioned to the substrate processing position P3, and the opposing surface 5b of the spin base 5 and the rim portion TR of the other major surface W2 of the substrate W are positioned opposed against and close to each other all around the circumference of the substrate W (Step S4). The substrate supporting head 71 is positioned inside the dent 5a of the spin base 5, while maintaining the substrate W sucked and supported.

The substrate W supported by the substrate supporting head 71 may be set to move in a very small amount, e.g., about 0.1 mm each, which permits finely adjusting the gap G between the opposing surface 5b of the spin base 5 and the rim portion of the other major surface W2 of the substrate W. For example, the gap G is finely adjusted considering the following factor. That is, for the purpose of preventing entry of the processing liquid into the device-forming area which is created in a non-processing area NTR (FIG. 3) of the other major surface W2 of the substrate W, the control unit 80 opens the flow rate adjusting valve 13, thereby supplying the inert gas from the gas supply path 11 into the entire space which is created between the other major surface W2 of the substrate W and the top surface of the spin base 5 via the space which is created between the bottom surface of the substrate supporting head 71 and the bottom surface of the dent 5a. Together with the inert gas ejected from the substrate supporting head 71, the inert gas supplied into the space which is created between the other major surface W2 of the substrate W and the top surface of the spin base 5 gushes outward along the diameter direction all around the circumference of the substrate W from the gap between the rim portion TR of the other major surface W2 of the substrate W and the opposing surface 5b of the spin base 5. At this stage, force upward away from the spin base 5 acts upon the rim of the substrate W, due to the pressure of gas flows of the inert gas. In short, upon the rim of the substrate W, in addition to a force of the weight of the substrate W of its own (self-weight) and a force to suck toward the substrate supporting head 71 by the Bernoulli effect, a force upward away from the spin base 5 because of the gas erupting from the gap between the rim portion TR of the other major surface W2 of the substrate W and the opposing surface 5b of the spin base 5 acts. Therefore, the balance between the forces determines the gap G between the opposing surface 5b of the spin base 5 and the rim portion TR of the other major surface W2 of the substrate W. Hence, it is necessary to finely adjust the gap G in light of the factor above, for setting the gap G to a desirable value. In relation to this, only the flow rate of the inert gas ejected toward the other major surface W2 of the substrate W from the substrate supporting head 71 determines floating of the substrate W from the substrate supporting head 71, and the substrate W is set so as to float up to a predetermined extent while sucked to the substrate supporting head 71. Hence, as the substrate supporting head 71 ascends and descends, the gap G is uniformly fine-tuned all around the circumference of the substrate W (Step S5).

The movable holders 4c and 4d of the hold pins move to the substrate holding positions which abut on the edge circumference surface of the substrate W, whereby the unprocessed substrate W thus positioned in the up-down direction is held firmly in the horizontal direction (Step S6). Following this, the processing liquid is supplied to one major surface W1 of the substrate W from the nozzle 100 which has moved from a stand-by position not shown. Further, the spin base 5 is driven into rotations, and therefore, the substrate W held by the holders 4a through 4d rotates, the processing liquid supplied to one major surface W1 of the substrate W spreads owing to centrifugal force, and one major surface (non-device-forming surface) W1 of the substrate W is processed. Furthermore, the processing liquid supplied to one major surface W1 of the substrate W circles down to the other major surface (device-forming surface) W2 of the substrate W via the edge surface of the substrate W from one major surface W1 of the substrate W, and the rim portion TR of the other major surface W2 of the substrate W is processed (bevel processing) (Step S7).

At this stage, the opposing surface 5b of the spin base 5 and the rim portion TR of the other major surface W2 of the substrate W are positioned opposed against and close to each other all around the circumference of the substrate W. And the inert gas gushes outward along the diameter direction of the substrate W from the gap between the opposing surface 5b of the spin base 5 and the rim portion TR of the other major surface W2 of the substrate W. Therefore, the processing liquid is prevented from jumping back to the other major surface W2 of the substrate W and the misty processing liquid is prevented from circling down to the other major surface W2. This in turn prevents the processing liquid from corroding the device-forming area which is created in the non-processing area NTR (FIG. 3) of the other major surface W2 of the substrate W. In addition, since the other major surface W2 of the substrate W is blocked by the inert gas supplied into the space which is created between the top surface of the spin base 5 and the other major surface W2 of the substrate W from the ambient atmosphere around the substrate W while being supported without contacting anywhere, adhesion of particles to the other major surface W2 of the substrate W is suppressed.

Unloading of the processed substrate W is executed in the opposite order to that of loading of the unprocessed substrate W. That is, after the predetermined processing of the substrate W, the hold pins of the movable holders 4c and 4d move in the direction away from the outer circumferential edge surface of the processed substrate W and the substrate W is consequently released from holding (Step S8). Following this, the control unit 80 drives the actuator 74 to ascend, which causes the substrate supporting head 71 which has been positioned inside the dent 5a to move upward. As the processed substrate W moves up to the substrate transfer position P1, the actuator 74 is stopped and the substrate W is positioned at this position (Step S9). The substrate supporting head 71 can therefore hand the processed substrate W over to the substrate transportation robot. By the transportation arm of the substrate transportation robot or the like, the processed substrate W is then discharged to outside the apparatus (Step S10).

As described above, according to this embodiment, the substrate supporting head 71 positioned opposed against the approximately central portion of the other major surface W2 of the substrate W stably sucks and supports the substrate W approximately horizontally without contacting the substrate W. Since the substrate W ascends and descends as it is supported approximately horizontally by the substrate supporting head 71, it is possible to adjust the gap G between the opposing surface 5b of the spin base 5 and the rim portion TR of the other major surface W2 of the substrate W to any value and uniformly all around the circumference of the substrate W. Further, the entire substrate supporting head 71 can be positioned inside the dent 5a of the spin base 5. That is, the top surface 71a of the substrate supporting head 71 is below the plane of the opposing surface 5b of the spin base 5. Therefore, the substrate supporting head 71 will not serve as an obstacle in reducing the gap G, and the rim portion TR of the other major surface W2 of the substrate W and the opposing surface 5b of the spin base 5 can be positioned sufficiently close to each other. It is thus possible to make the rim portion TR of the other major surface W2 of the substrate W and the opposing surface 5b come close to each other uniformly all around the circumference of the substrate W while supporting the substrate W without contacting anywhere. Therefore, it is possible to effectively prevent contamination of the other major surface W2 of the substrate W with the processing liquid jumping back to the other major surface W2 or the misty processing liquid circling down to the other major surface W2, while avoiding damaging of the other major surface W2 of the substrate W.

Further, according to this embodiment, while it is possible to perform uniformly processing one major surface W1 of the substrate W and to perform uniformly processing one major surface W1 and the rim portion TR of the other major surface W2 of the substrate W, by driving the spin base 5 into rotation, it is not necessary to rotate the substrate supporting head 71. Therefore, it is possible to simplify the structure of the substrate elevating mechanism 7 including the substrate supporting head 71 and to achieve easy and efficient supply of the inert gas to the substrate supporting head 71.

Further, according to this embodiment, the substrate supporting head 71 sucking and supporting the substrate W moves upward and downward, whereby the opposing surface 5b of the spin base 5 and the rim portion TR of the other major surface W2 of the substrate W are positioned close to each other. Therefore, it is possible to reduce the amount of the inert gas which is consumed. That is, by increasing the flow rate of the inert gas erupting from the gap between the opposing surface 5b of the spin base 5 and the rim portion TR of the other major surface W2 of the substrate W, the processing liquid is prevented from jumping back to the other major surface W2 of the substrate W and the misty processing liquid is prevented from circling down to the other major surface W2. However, the increase of the gas flow rate enlarges the gap G between the opposing surface 5b of the spin base 5 and the rim portion TR of the other major surface W2 of the substrate W. This results in an extreme increase of the gas flow rate. According to this embodiment however, the substrate W is positioned by moving the substrate supporting head 71 upward and downward, while the substrate W is sucked and supported by the substrate supporting head 71, that is, while maintaining the floating level of the substrate W from the substrate supporting head 71 at a certain level. Hence, the gap G is not broadened and it is possible to reduce the consumption of the inert gas.

The present invention is not limited to the embodiments described above but may be modified in various manners in addition to the embodiments above, to the extent not deviating from the object of the invention. For instance, although in the embodiment described above, the substrate supporting head 71 moves upward and downward as it keeps sucking and holding the substrate W, thereby adjusting the gap G between the opposing surface 5b of the spin base 5 and the rim portion TR of the other major surface W2 of the substrate W, this is not limiting. For example, the flow rate of the inert gas ejected toward the other major surface W2 of the substrate W from the substrate supporting head 71 may be controlled for adjustment of the gap G. Where this is exercised, as the control unit 80 adjusts the flow rate adjusting valve 75 and controls the flow rate of the inert gas ejected toward the other major surface W2 of the substrate W, it is possible to change the floating level of the substrate W from the substrate supporting head 71 (namely, the distance from the top surface 71a of the substrate supporting head 71 to the other major surface W2 of the substrate W). Further, since the inert gas adjusted to a predetermined flow rate is supplied from the substrate supporting head 71 evenly toward the rim of the substrate W along the circumferential direction about the vertical axis J, even force acts upon the substrate W along all the circumferential direction, whereby the floating level of the substrate W from the substrate supporting head 71 is changed while the substrate W keeps its horizontal posture. Hence, it is possible to adjust the gap G between the opposing surface 5b of the spin base 5 and the rim portion TR of the other major surface W2 of the substrate W to any desired value and uniformly all around the circumference of the substrate W. In this embodiment, the flow rate adjusting valve 75 thus functions as the “flow rate controller” of the present invention which controls the flow rate of the inert gas which is supplied to the substrate supporting head 71.

Further, the control unit 80 may adjust the gap G between the opposing surface 5b of the spin base 5 and the rim portion TR of the other major surface W2 of the substrate W, by both moving the substrate supporting head 71 upward and downward which sucks and supports the substrate W, and changing the floating level of the substrate W from the substrate supporting head 71. That is, the control unit 80 drives the actuator 74, thereby moving the substrate supporting head 71 upward and downward, and the control unit 80 adjusts the flow rate adjusting valve 75 and controls the flow rate of the inert gas, thereby changing the floating level.

Further, in the embodiment above, the substrate supporting head 71 is positioned below the substrate W with the other major surface W2 of the substrate W faced down, and the inert gas is ejected toward the other major surface W2 of the substrate W and the substrate W is accordingly sucked and supported, this is not limiting. The substrate supporting head 71 may be positioned above the substrate W with the other major surface W2 of the substrate W faced up and the inert gas may be ejected toward the other major surface W2 of the substrate W, to thereby suck and support the substrate W.

Further, in the embodiment above, the gap G between the opposing surface 5b of the spin base 5 and the rim portion TR of the other major surface W2 of the substrate W is adjusted by ascending and descending the substrate supporting head 71. However, the spin base 5 may be moved upward and downward while the substrate supporting head 71 remains fixed, to thereby adjust the gap G. Alternatively, the substrate supporting head 71 and the spin base 5 both may be moved upward and downward for adjustment of the gap G.

Further, in the embodiment above, the entire substrate supporting head 71 is positioned inside the dent 5a of the spin base 5 when the substrate supporting head 71 descends, this is not limiting. Instead, at least the rear portion of the substrate supporting head 71 may be inside the dent 5a below the plane of the opposing surface 5b. That is, in positioning the substrate W to the predetermined substrate processing position P3, even if the top surface 71a of the substrate supporting head 71 is outside the dent 5a above the plane of the opposing surface 5b, as long as the top surface 71a remains lower than the other major surface W2 of the substrate W which has been positioned at the substrate processing position P3, similar effects to those according to the embodiment above are obtained.

Further, in the embodiment above, as shown in FIG. 2, plural groups of the gas ejection outlets 71b (each group includes the five ejection outlets 71b) are arranged equidistant from each other along the rim of the top surface 71a of the substrate supporting head 71, but the number and the arrangement of the gas ejection outlets 71b may be determined freely. For instance, a greater number of the gas ejection outlets 71b may be arranged densely in a row along the rim of the top surface 71a. However, in the embodiment above, it is not the ejection of the inert gas from the gap between the top surface 71a of the substrate supporting head 71 and the other major surface W2 of the substrate W all around the circumference of the substrate W with the top surface 71a of the substrate supporting head 71 and the other major surface W2 of the substrate W being close to each other that prevent contamination of the other major surface W2 of the substrate W with the processing liquid. In other words, contamination of the other major surface W2 of the substrate W with the processing liquid is prevented since the opposing surface 5b of the spin base 5 and the other major surface W2 of the substrate W are positioned close to each other. Therefore, it is not necessary to eject the inert gas all around the circumference of the substrate W from the top surface 71a of the substrate supporting head 71. Hence, in the embodiment above, as long as sucking and supporting the substrate W approximately horizontally, it is not necessary to design the arrangement of the ejection outlets to attain the exact gas ejection considering contamination with the processing liquid, etc.

The present invention is applicable to a substrate processing apparatus which performs processing such as cleaning to the surfaces of substrates in general including semiconductor wafers, glass substrates for photomask, glass substrates for liquid crystal display, glass substrates for plasma display and optical disk substrates.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing apparatus which performs predetermined processing by supplying a processing liquid to one major surface of a substrate, comprising:
a substrate supporting device which includes a substrate supporting head and which ejects gas from a front portion of said substrate supporting head toward a rim of the other major surface of said substrate while the front portion of said substrate supporting head is opposed against an approximately central portion of the other major surface of said substrate, whereby said substrate supporting head sucks said substrate by the Bernoulli effect and supports said substrate approximately horizontally without contacting said substrate;
a base member which has an opposing surface opposed against the other major surface of said substrate and which is provided with a dent which is formed approximately at a central portion of the opposing surface, and a plane size of which is larger than a plane size of said substrate supporting head, whereby at least a rear portion of said substrate supporting head can be positioned inside the dent below a plane of the opposing surface; and
an adjuster which moves said substrate sucked and supported by said substrate supporting head upward and downward relative to said base member, whereby a gap between the opposing surface of said base member and a rim portion of the other major surface of said substrate is adjusted.

2. The substrate processing apparatus of claim 1, wherein
said substrate supporting device further includes a gas supplying unit which supplies gas to said substrate supporting head.

3. The substrate processing apparatus of claim 1, wherein
a plane size of said substrate supporting head is smaller than a size of said substrate; and
said substrate supporting head includes a gas ejection outlet formed inclined toward a rim of the other major surface of said substrate.

4. The substrate processing apparatus of claim 1, wherein
said adjuster includes an up-and-down driver which moves said substrate supporting head which sucks and supports said substrate upward and downward relative to said base member, whereby the gap between the opposing surface of said base member and the rim portion of the other major surface of said substrate is adjusted.

5. The substrate processing apparatus of claim 1, wherein
said adjuster includes a flow rate controller which controls a flow rate of gas which is ejected from said substrate supporting head, whereby the gap between the opposing surface of said base member and the rim portion of the other major surface of said substrate is adjusted.

6. The substrate processing apparatus of claim 1, wherein
a size of a depth of the dent is larger than a size of a height of said substrate supporting head along an up-and-down direction; and
said predetermined processing is performed while an entirety of said substrate supporting head is inside the dent below a plane of the opposing surface.

7. The substrate processing apparatus of claim 1, further comprising a rotating device which rotates said base member, wherein
said base member includes a holder which holds said substrate, and
said rotating device rotates said base member, thereby rotating said substrate which is held by said holder.

8. A substrate processing method in which predetermined processing is performed by supplying a processing liquid to one major surface of a substrate, comprising:
a step of ejecting gas from a front portion of a substrate supporting head toward a rim of the other major surface of said substrate while the front portion of said substrate supporting head is opposed against an approximately central portion of the other major surface of said substrate, for said substrate supporting head to suck said substrate by the Bernoulli effect and to support said substrate approximately horizontally without contacting said substrate; and
a step of adjusting a gap between a rim portion of the other major surface of said substrate and an opposing surface of a base member, the opposing surface being opposed against the other major surface of said substrate, said base member being provided with a dent which is formed approximately at a central portion of the opposing surface, and a plane size of which is larger than a plane size of said substrate supporting head, wherein
in said step of adjusting the gap, at least a rear portion of said substrate supporting head can be positioned inside the dent below a plane of the opposing surface.
